(19) United States
(12) Patent Application Publication
(10) Pub. No.: US 2009/0173601 A1
(43) Pub. Date: Jul. 9, 2009

(54) Auger conveyor

(76) Inventor: Robert Clark Tyer, Jacksonville, FL (US)

Correspondence Address: Robert Clark Tyer, 12794 Burning Tree Lane West, Jacksonville, FL, 32223, US

(21) Appl. No.: 12/319,535

(22) Filed: Jan. 8, 2009

Related U.S. Application Data
(60) Provisional application No. 61/010,440, filed on Jan. 9, 2008.

(51) Int. Cl. B65G 33/26

(52) U.S. Cl. 198/676

(57) ABSTRACT

A means for improving an auger conveyor consisting of a support shaft with plural flight sections, coaxially layered upon the said shaft made to rotate said section or sections with independent or dependent revolutions or directions on command and incorporating radial slots in the standoffs so that a helical ribbon is allowed to thermally expand thus retaining its concentric tolerance range

### CROSS-REFERENCE TO RELATED APPLICATIONS

This application claims the benefit of provisional patent application Ser. No. 61/010,440, filed Jan. 9, 2008 by the present inventor.

### FEDERALLY SPONSORED RESEARCHED

Not Applicable.

### SEQUENCE LISTING OR PROGRAM

Not Applicable

### BACKGROUND

1. Field of Invention

This invention relates to conveying materials, specifically to auger conveyors which are used to move, blend, or mix Materials or Liquids.

2. Prior Art

Conventional auger conveyors consisting of a helical screw that rotates upon a single shaft with a stationary trough or casing which can move bulk material along a horizontal inclined or vertical plane are well recognized by those skilled in the art. The volume of material moved by conventional augers is determined by:

An auger conveyor designed for a specific application, example diameter or pitch of flight.

An augers revolution being either increased or decreased An augers rotational direction being clockwise or counterclockwise.

These auger conveyor basics above restrict the conveying flexibility in terms of volume of a material moved for any given auger conveyor; furthermore, the lack of conventional auger conveyor flexibility is compounded when material processing is combined with material movement. At the inlet of the auger conveyor a material may require mixing or blending at one rotation speed but as the material begins to react as it is mixed or blended while moving through the trough or casing a different auger rotation speed may be required to eliminate the possibility of clogging, jamming etc,. Example: These problems exists, but are not limited to, a continuous process such as in preparing bakery goods, paint mixing or moving fuel material through an auger combustor/gasifier.

Attempts have been made to improve auger conveying flexibility by varying flight pitch, tapered augers and varying auger revolutions. All of the above in various combinations have been implemented in an attempt to improve auger conveying flexibility resulting in marginal improvements in material conveyance. Single shaft auger conveyors have been used to move solid fuel through a combustion chamber. The optimal performance of a single shaft auger works most effectively when the fuel is consistent in type, moisture content and particle size. Example: Wood chips.

A continuously flighted, single shafted auger conveyor within a single encasement which moves “fuels”, such as but not limited to: solid municipal waste, which is a heterogeneous mixture of many combustibles with varying moisture content, cannot convey raw wet fuel slowly to dry it out while simultaneously increasing the revolutions for general gasification. Neither can it decrease the revolutions of the auger rotation to efficiently gasify the free carbon. Some of the disadvantages associated with the inability to remove the free gas carbons from within the single encasement are: less then optimum gasification and the requirement of greater air quality control at the end of the gasification process.

As the solid fuel becomes less homogeneous (such as but not limited to solid municipal waste), the continuously flighted, single shafted auger conveyor becomes less and less efficient.

### SUMMARY

A means for improving an auger conveyor consisting of a support shaft with plural flight sections, coaxially layered upon the said shaft made to rotate said section or sections with independent or dependent revolutions or directions.

### DRAWINGS

FIG. 1A TO FIG. 4A show various aspects of the means for improving an auger conveyor.

FIG. 1A shows the support shaft numbered 5.

FIG. 1A shows the plural sections numbered 12, 13, 14 & 15.

FIG. 1A shows the said sections coaxially layered upon said shaft numbered 5.

FIG. 1A shows the flights disposed slidably contiguous to the said sections by plural standoffs number 11.

### DRAWINGS—REFERENCE NUMERALS

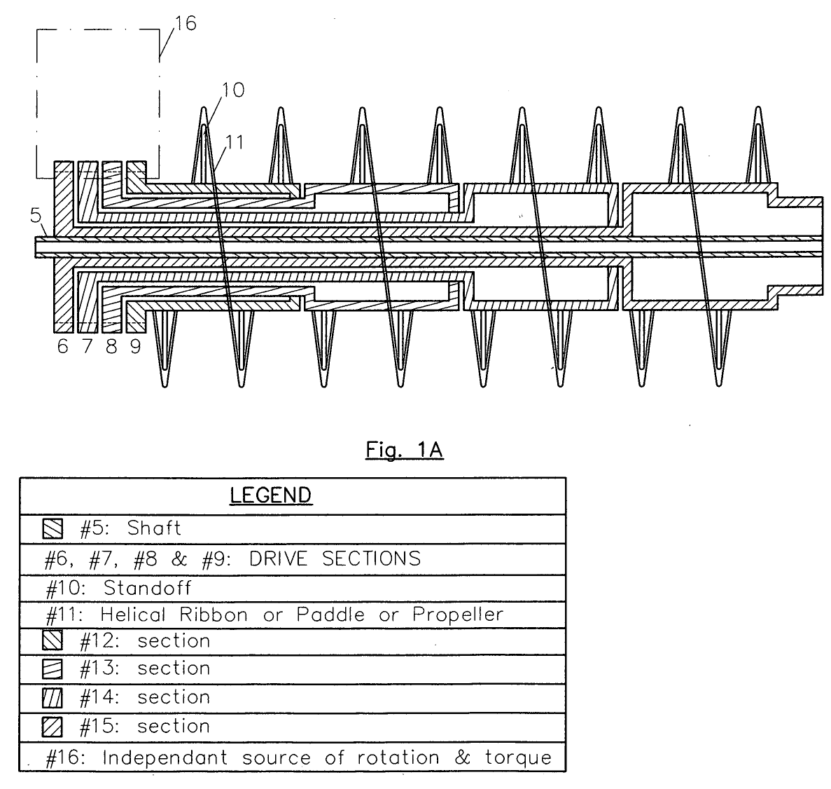

FIG. 1A is a side view of the improved auger conveyor.

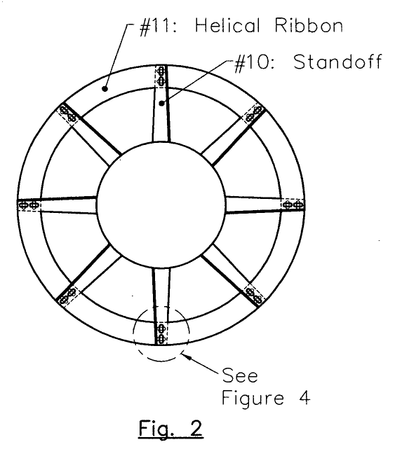

FIG. 2A is a sectional view of a contiguous slidable helical ribbon.

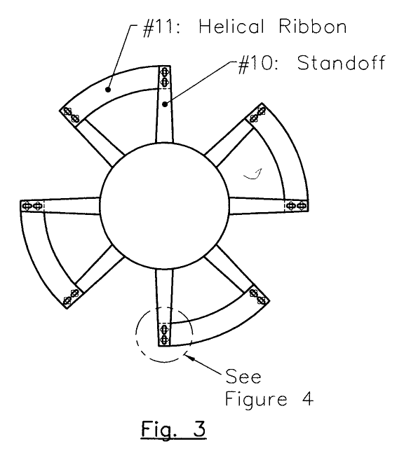

FIG. 3A is a sectional view of said helical ribbon shown as a paddle.

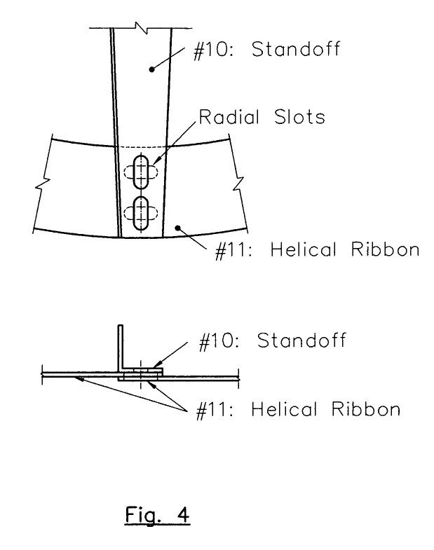

FIG. 4A is a detail of the radial slots which is Embodiment #2.

5—Shaft

6, 7, 8, & 9—Drive Sections

10—Standoff

11—Can be but not limited to: Helical Ribbon, Paddle, Bucket or Propeller.

12, 13, 14 & 15—Cross sections of said plural flight sections, coaxially layered.

### Embodiment One; Detailed Description—FIG. 1A and Numerals 5, 6, 7, 8, 9, 10, 11, 12, 13, 14, & 15

Embodiment One of the Improved Auger Conveyor is illustrated in FIG. 1A (side view) In FIG. 1A, upon each plural flight section 12, 13, 14 & 15 plural standoffs number 10 to which either can be attached or not, a helical ribbon number 11 and disposed slidably contiguous coaxially to the shaft Number 5. Said sections number 12, 13, 14 & 15 have independent drive mechanism numbered 6, 7, 8, & 9.

### Embodiment One; Operational Description—FIGS. 1A, 2A and Numerals 5, 6, 7, 8, 9, 10, 11, 12, 13, 14, & 15

Embodiment number one of the Improved Auger Conveyor is illustrated in FIG. 1A (side view) and FIG. 2A (end view). In FIG. 1A, Number 5 Hollow shaft it can support both the weight of the plural coaxially layered flight sections and the materials that the flight sections are conveying.

Said shaft section number 5 is the axle upon which said flight sections revolve but is not the source of their rotation.

Said section 12, 13, 14 & 15 are rotated independent on command of other said sections by a independent source of rotation and torque. EXAMPLE: Flight section 12, 5 rpms, clockwise rotation; flight section 13, 10 rpms counterclockwise rotation, flight section 14, 22 rpms clockwise rotation and flight section 15, no rotation. As one skilled in the art could see there are virtually unlimited combinations of revolutions per minute and rotational direction within this embodiment.

### Embodiment Two; Detailed Description—FIG. 4A and Numerals 10, 11

Embodiment number two of the Improved Auger Conveyor is illustrated in said FIGS. 2A, 3A and FIG. 4A (detail view). Embodiment two of the Improved Auger Conveyor is the helical ribbon number 11 incorporates radial slotting and standoff number 10 incorporates a oblong slot perpendicular to the radial chord slot of said helical ribbon number 11 and is disposed slidably upon the said standoff.

### Embodiment Two; Operational Description—FIG. 4A and Numerals 10, 11

Embodiment number two of the Improved Auger Conveyor is illustrated in said FIGS. 2A, 3A and FIG. 4A (detail view). Embodiment two of the Improved Auger Conveyor is standoff number 10 incorporates radial slots so that a helical ribbon number 11 is allowed to thermally expand thus retaining a concentric tolerance range

### Advantages

From the descriptions above, a number of advantages of embodiments of the improved auger conveyor become evident: Embodiment One are advantages A, B, C, & D; Embodiment Two are advantages E, F & G.
(A.) An auger manufacturer by virtue of the improved auger will now be able to produce in quantity by manufacturing like parts. Prior art requires the auger manufacturer to produce an auger to a specific design application. One auger can fit many buyers' needs. The improved auger conveyor will allow for a greater variety of auger designs and performances. The coaxial-layered design allows for satisfying individualized conveying requirements by purchasers assembling of common components.
(B.) User of the improved auger will need fewer parts in stock especially if more then one auger conveyor is in use at one location. Parts are interchangeable from auger to auger.
(C.) User can easily vary the augers performance to meet changes in products or materials being conveyed or processed.
(D.) Users can run continuous streams of product thus eliminating individual batching operations.
(E.) Users can apply the improved auger in conveying, mixing and blending applications where thermal expansion distortion of the said helical flight system would diminish auger performance and life cycle.
(F.) User can shorten down time when said slidable components need to be replaced and or repaired.
(G.) Auger flexibility is improved by the means of said auger ribbons being replaced by a different configuration or paddle system by the slidable interface of the helicals radial slot.

### Conclusion, Ramifications and Scope

Accordingly, the reader will see that the improved auger conveyors of the various embodiments can be used as both an instrument for conveying material and/or mixing material. In addition, it allows for on command adjustments to conveying capabilities and/or mixing capability. Many industrial processes that have historically been restricted to batching can be a continuous process whereby raw materials are introduced into auger and a final product exits. The elimination or reduction in batching will improve worker safety in many industries. With the worlds increasing need for alternative energy, it will improve the gasification of solid fuels like biomass.

We can it increase the revolutions of the auger rotation to gasify free carbon thus increasing gasification performance and reducing atmospheric pollution.

1. I claim: A means for improving an auger conveyor consisting of a support shaft with plural flight sections, coaxially layered upon the said shaft made to rotate said section or sections with independent or dependent revolutions or directions on command
I claim: a means for improved auger conveyor incorporates radial slots in the standoffs so that a helical ribbon is allowed to thermally expand thus retaining its concentric tolerance range.
